(19) United States
(12) Patent Application Publication
(10) Pub. No.: US 2004/0098356 A1
(43) Pub. Date: May 20, 2004

(54) Expert decision making system for the release and handling of supervised commercial imports

(76) Inventor: Ben-Zion Shabtai, Ramat Hasharon (IL)

Correspondence Address: KATTEN MUCHIN ZAVIS ROSENMAN, 575 MADISON AVENUE, NEW YORK, NY, 10022-2585, US

(21) Appl. No.: 10/300,607

(22) Filed: Nov. 20, 2002

(51) Int. Cl. G06F 17/00; G06N 5/00; G06F 17/60

(52) U.S. Cl. 706/45; 705/1

(57) ABSTRACT

The present invention is a universal on-line expert system for automatic decision making in the release, handling, transportation and distribution of high-risk goods that would normally require manual examination. The system comprises of several databases that contain the authorities' rules, license information of certified users, and pre-designed electronic data sheets for various types of goods. Relevant information about the goods is sent to the system by a certified user through the Internet or similar type network, and the confirmation or non-confirmation of the goods' compliance with authorities' rules is verified by the system prior to the transportation of the goods.

### FIELD OF THE INVENTION

The invention relates to an on-line governmental expert information system and method, and specifically to an expert system that automatically makes decisions regarding the release, handling, transportation and distribution of supervised commercial imported goods which require clearance confirmation. Incorporating a capacity to track handling and transportation in compliance with national and international laws and regulations, the system empowers the enforcement capability of national authorities.

### BACKGROUND

A country's customs service is the primary enforcement agency responsible for protecting the nation's borders against illegal import/export of goods. Among other things, the Customs Service processes imports to the country and inspects them, in order to ensure compliance with rules and regulations pertaining to other government agencies such as: public health, safety, environmental protection, security, etc.

The U.S. Customs Service typically processes imports on a transactional basis, and must interact with many different parties (such as importers, carriers, suppliers) to process these transactions. The different parties must also interact with each other in order to process a single transaction.

The complex nature of Customs Service rules, necessitates extensive communication among the involved parties. Complying with a myriad of rules and regulations, and tracking the vast number of import transactions processed daily, are challenging tasks for the parties involved.

In order to process this data, the U.S.A. Customs Service uses automated systems such as the Automated Commercial System (ACS). This system currently tracks, controls, and processes commercial goods imported into the United States, but this system is not able to meet the complex requirements of all governmental entities. The U.S. Customs Service has declared the development of a new ACS system (hereinafter referred to as the New ACS System).

The New ACS System is designed to permit certified users to submit import data in electronic form. The system sorts the incoming data according to cargo type, by means of established criteria, and identifies high-risk cargo, in order to determine the proper examination procedure for each type or class of imported goods. The System transfers import data to other governmental agencies for further investigation. The import data of low risk type is examined against national and local criteria and provides certified users with electronic authorization.

The New ACS System suffers from two crucial deficiencies. Firstly, the System is designed to identify high risk goods and to determine the proper examination procedure for each case but is not designed to perform the confirmation procedure. The confirmation of high risk material therefore requires the intervention of a human examiner. The second problem concerns the System's underlying requirement to adhere to the different rules and regulations of a plurality of different governmental authorities, such as the Department of Health, Ministry of Defense, Environmental Department (hereinafter: “Authorities' Rules and Regulations”). Today, the ACS System is required to perform, in respect of each class of goods, a different examination procedure in order to comply with the Authorities' Rules and Regulations. Thus, the process of checking goods compliance is both complicated and cumbersome. Further more, according to a report published in 1999 by the U.S. Customs (“Trade Compliance Risk Management Process”), the ACS system performs only a partial check, by a “Compliance Measurement Sampling Plan”, whilst the present invention presents a system that is able to perform a complete inspection (of goods details compliance) in respect of 100% of the supervised commercial imports.

Most prior art customs information systems are mainly designed to deal with the financial transactions of importing and exporting procedures.

Recently, patent application Ser. No. WO0235382 disclosed a seamless electronic international trading system across national borders. This application deals with the process of checking the compliance of imported goods, but no solution is provided for an automatic confirmation of high-risk goods' compliance with the polarity Authorities' Rules and Regulations.

As the problems concerning compliance confirmation remain unsolved, a new system is required to efficiently deal with international import/export transactions. On such complicated grounds, involving many different parties and organizations, an in-depth and time-consuming analysis of various functional and technical requirements is necessary in order to develop an appropriate solution.

It is the object of the present invention to avoid the deficiencies of the prior art customs information systems and provide an efficient and automatic decision making expert system for checking the compliance of transported goods with all Authorities' Rules and Regulations.

### SUMMARY OF THE INVENTION

The present invention is a universal on-line expert system for automatic decision making in the release, handling, transportation and distribution of imported and exported goods. In particular, the system relates to high-risk or hazardous goods that would normally require human intervention to examine. These decisions are based on data pertaining to the goods in question, according to at least one set of authorities' rules and regulations relating to the import/export of goods and license limitations of the certified user relating said goods.

The system comprises of several databases that contain the authorities' rules, license information of certified users, and pre-designed electronic data sheets for various types of goods. All components and means of communication may be provided through the Internet or similar type network, enabling users to send required information about the goods from any convenient location and receive a confirmation or non-confirmation of their goods' compliance with authorities' rules prior to transporting the goods.

According to the system, the intervention of a human examiner will only be required when a user has received a non-confirmation of goods' compliance with authorities' rules. Use of the system would be very time and cost effective for the Customs Service, as currently all high-risk materials are examined manually.

### BRIEF DESCRIPTION OF THE DRAWINGS

These and further features and advantages of the invention will become more clearly understood in light of the ensuing description of a preferred embodiment hereof, given by way of example only, with reference to the accompanying drawings, wherein

FIG. 1 is a general diagrammatic representation of the environment in which the present invention is practiced;

FIG. 2 is a block diagram of the supervision system according to the present invention;

FIG. 3 is a diagram illustrating the process flow of checking and confirming goods compliance according to the present invention;

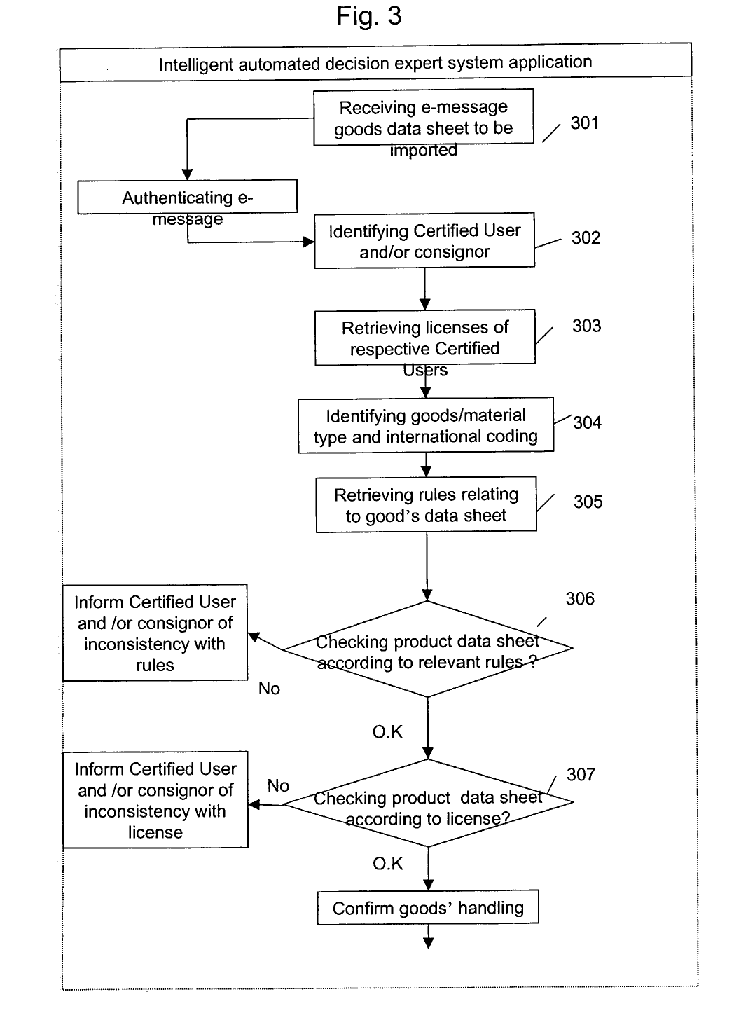

FIG. 4 is flow-chart illustrating the data interchange process according to the present invention;

FIG. 5 is flow-chart illustrating the databases management process according to the present invention;

FIG. 6 is flow-chart illustrating online goods tracking process according to the present invention;

### DETAILED DESCRIPTION OF THE PREFERRED EMBODIMENTS

The invention provides a new expert decision making tool for facilitating an efficient and easy-to-use procedure for the automatic confirmation of goods' compliance with a multitude of authorities' rules.

The investigation procedure of goods' compliance is more acute when dealing with high-risk or hazardous materials as well as any other type of goods that require formal examination and authorization before clearance (such as chemical, nuclear or medical materials, food, animals, plants, or communication systems) (hereinafter “Goods Requiring Supervision”). The supervision of importation and handling of goods, which require supervision, is of great importance to most of all national competent authorities. The permission to import, handle and use (hereinafter “Licenses”) these goods is granted to limited number of importers and facilities, such as industrial companies dealing with hazardous materials, or to medical institutes (hereinafter “Certified Users”). The supervision of such goods is primarily preformed by the customs authorities, hence the preferred embodiment of this invention relates to the importation procedure carried out by governmental authorities. However, the basis of the expert system according to the present invention, is to enable the follow-up process (tracking) of Goods Requiring Supervision throughout supply chain process: from the production/manufacture stage through to the final usage (“From cradle to grave”).

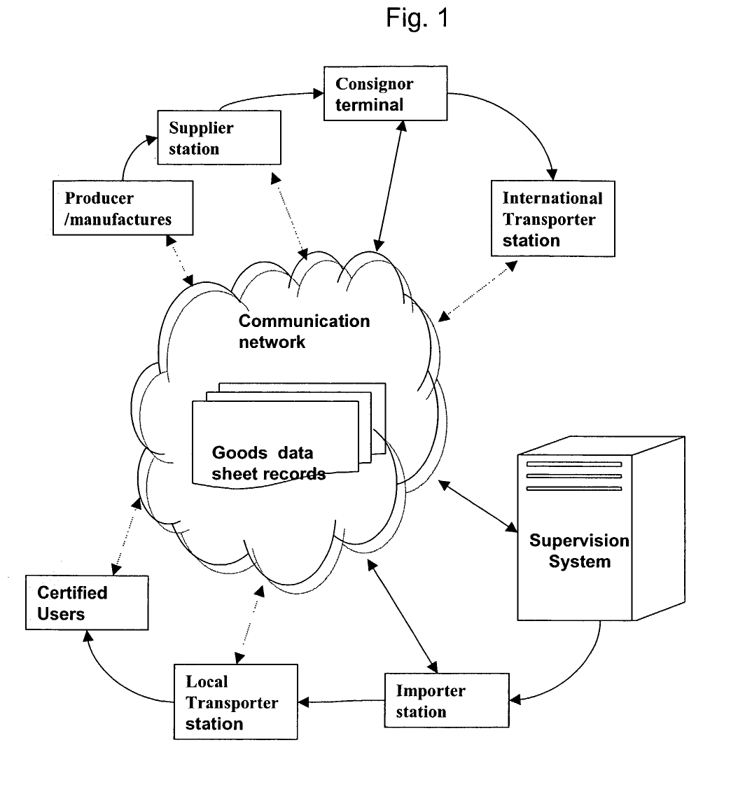

FIG. 1 illustrates the complete cycle of the flow of goods (supply chain process) in which the present invention is practiced. In order to enable automatic information flow and confirmation process, special data sheets are designed, which are recorded in electronic form. These data sheets are designed to include all relevant examination information that covers the requirements of all the Authorities' Rules and Regulations. Each type of goods has different kinds of characteristics, thus for each goods category a special data form is created to include all relevant parameters. The categorization of goods is based on the international harmonized Customs coding system (of the WCO organization).

In FIG. 1, all entities that are involved in the flow cycle are detailed. The materials are manufactured by a foreign manufacturer, which provides the goods' characteristic data. This data information is forwarded to the supplier or directly to the consignor. This data may be transferred in electronic or tangible form. The consignor is obliged to enter the goods' characteristics into the designated data sheet form in order to satisfy all the competent authorities requirements (Consignors may perform a one time modification into their existing supply chain management system, for this purpose). The data sheet records are transferred through electronic communication, preferably through the Internet or any equivalent network. The data transfer through the network is secured and authenticated, using known technologies, including procedures of digital signatures. Thereafter, the data is checked and analyzed by the Supervision System. The Supervision System examines the goods' data sheets and determines if the goods can be imported according to the rules of a specific country. The system notifies the involved participants (the consignor, the importer, the competent authorities and the customs) of confirmation or non-confirmation relating to goods release (and/or handling transportation and/or distribution). A non-confirmation message is enclosed with relevant justification/argument and details of the rejection. This improved process of electronic data transfer between consignor/Certified User and governmental authorities prevents data errors in comparison to human manual process.

The Supervision System may further track the supervised goods transportation, distribution, usage and evacuation, through all the stages of the supply chain process. Such supervision is possible if all relevant participating Certified Users are obliged to provide the supervision system with information relating to the importation, transportation, or usage of the materials in electronic form, preferably through the Internet.

According to a further idea of the present invention, it is suggested to use smart cards, which will include all relevant information of the user's license for Goods Requiring Supervision. These smart cards will replace the paper licenses, and will be issued and updated by the government authorities. A smart card, will be operated on the principle of “phone-card” or even “smart credit card” (with limited amounts of permitted values for usage of each material). For each supervised operation, the user will insert the smart card into a reader and be identified. Then, he will choose one of the menu's options (release/transportation/receiving.). Each Certified User (importer/transporter/user) will be obliged to use this system. The license (smart card) will be issued for limited periods, for limited amounts of materials, and for a specific Certified User. It will also be used as “back-up” means, in case of computer problems.

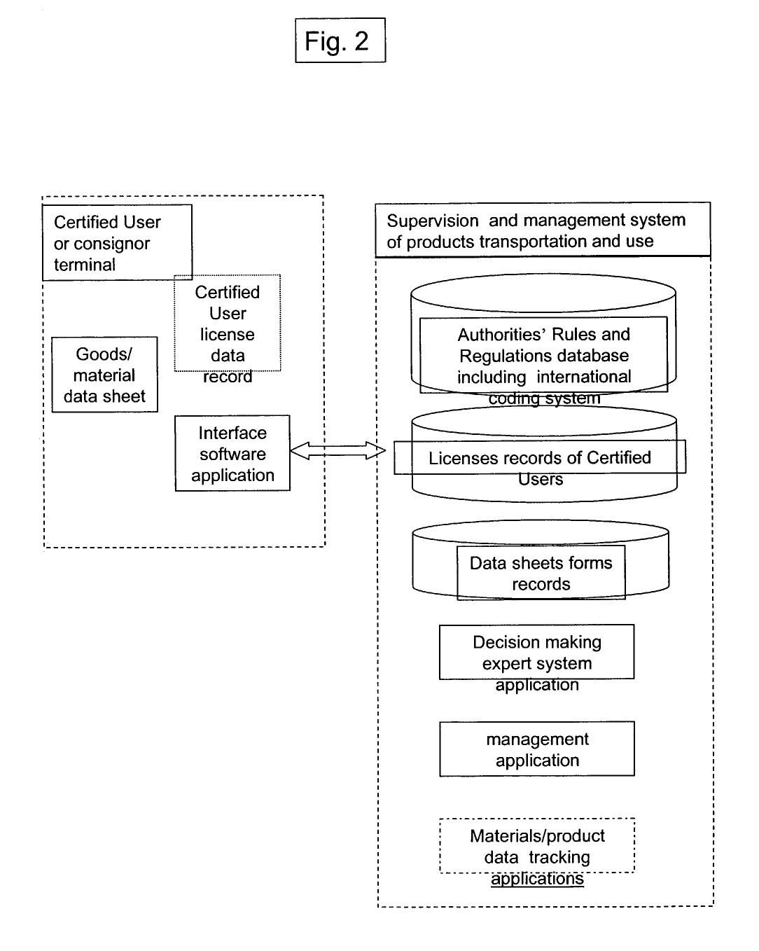

FIG. 2 illustrates a block diagram describing the essential components according to the present invention.

The Supervision System includes three databases. The first database includes records of Authorities' Rules and Regulations arranged according to material/goods categories, related Authorities and international customs coding. All rules are transformed into logical terms indicating the permitted range of values for each parameter representing the Goods Requiring Supervision material characteristics or composition. The second database includes license records, each license record includes detailed information of granted permissions to Certified Users. The data record of each Certified User includes a list of all types of permitted materials and goods and the different conditions the Certified User is obliged to maintain. The conditions are represented as logic limitations of material characteristics and compositions.

The third database includes pre-designed data sheet forms. Each data sheet is specially designed for a specific category of materials and includes all relevant parameters that define the materials' characteristics and compositions.

The fundamental component of the Supervision System is the decision making expert application. This application receives the data sheets of the imported goods (step 301) as specified by the Certified User or the consignor and identifies (step 302) the Certified user or consignor and the goods/material type (304). The license of the identified Certified User is retrieved (step 303) from the second database, and the relevant rules of all authorities are retrieved (step 305) from the first database. The application checks all goods/material characteristic values against the logical conditions of the retrieved license and the logical terms of the relevant Authorities' Rules and Regulations (step 306 and 307). If one of these characteristic values exceeds the threshold values as defined in any one of the logical conditions, then the goods importation is denied. The decision of approving or denying goods importation can be based on a combination of conditions relating different material characteristics. At the end of the assessment process, the Supervision System informs the involved participants (the consignor, the relevant Certified User, the relevant competent authorities and the customs) by e-mail or any other electronic form of its confirmation or denial of the goods importation. This investigation process may be performed prior to the physical action of transporting the goods and thus enables the consignor (by a way of a query) to know in advance if the delivered goods comply with the Authorities' Rules and Regulations. This element of the Supervision system is especially useful, as it eliminates costs related to the storage of goods while their compliance with the relevant Authorities' Rules and Regulations is assessed.

The interface of the Supervision System may be implemented by way of completion of online forms through the Internet, in which Certified Users may fill-in the data either manually or using unified formats data (e.g. XML) and exchange application software such as Microsoft's BizTalk or any data management software adapted to the supervision system interface, enabling automatic exchange between user applications and the Supervision System.

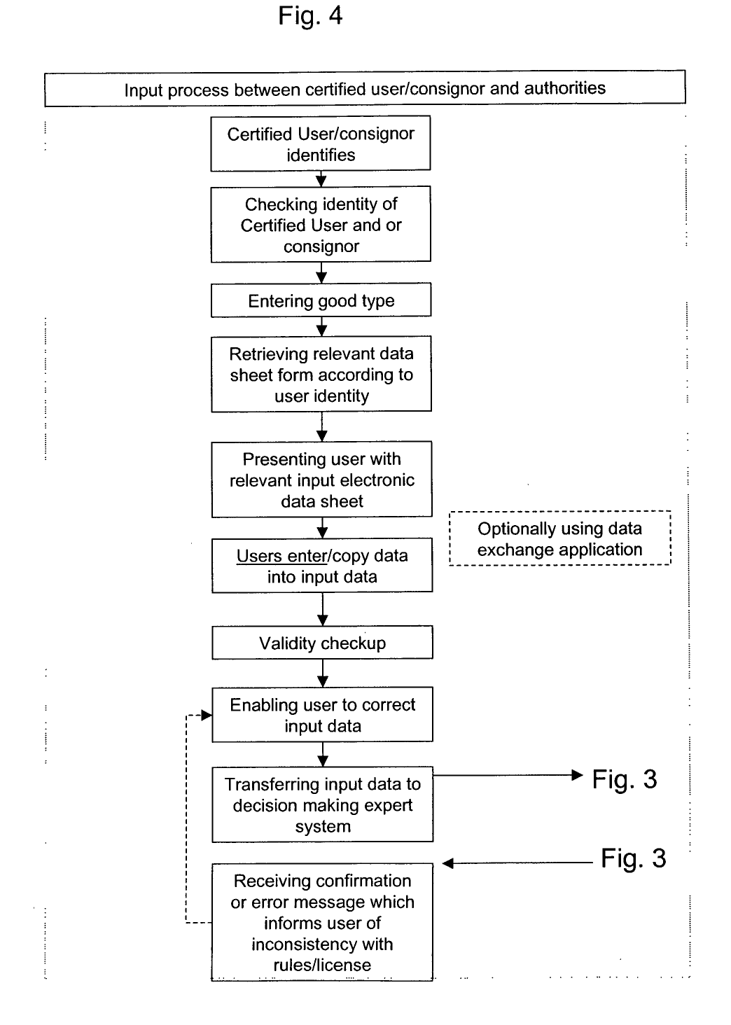

FIG. 4 illustrates data interface processing using the online forms option. First, the Certified User (or the consignor) is requested to fill-in it's identity (step 401) and to enter the goods/product type (403). Once the user is identified (402), the interface application retrieves (404) the proper data sheet form and presents the user with the respective data sheet fill-in screen (405). The user enters the data manually or automatically using the data exchange application. The interface application checks the validity of the data type and forms (406) and notifies the user of improper data type or errors, after which the user may change and edit the data accordingly. At the end of this process the data is transmitted to the decision expert system for investigation (as explained above) and in return, confirmation or non-confirmation of data compliance with Authorities' Rules and Regulations is received.

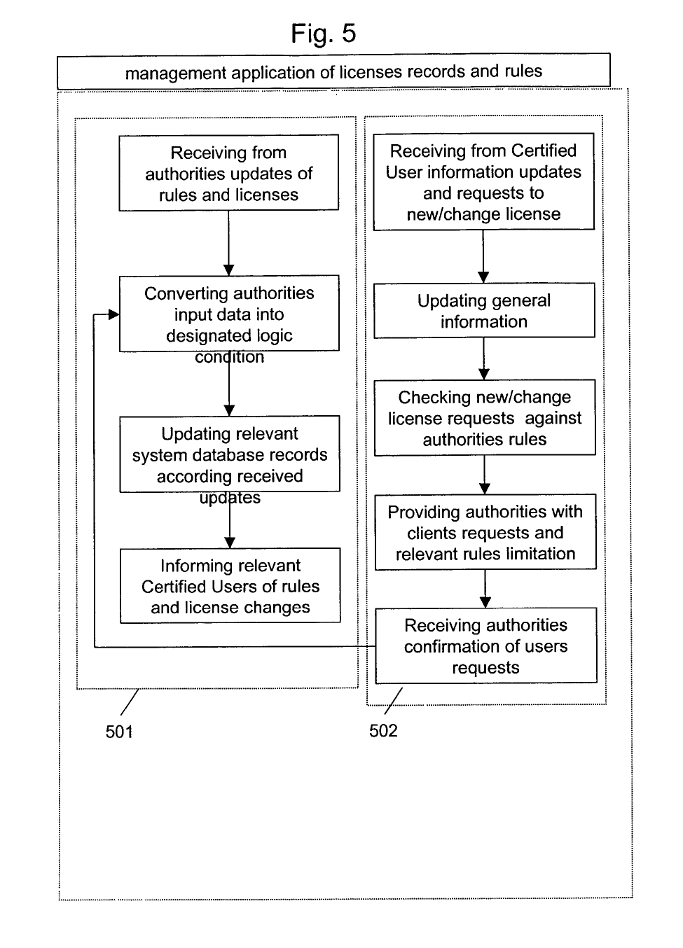

FIG. 5 illustrates the management application of the Supervision System databases. The first procedure (501) enables the Authorities to update the rules and regulations relating to importation of goods. When new rules are inserted, the application transforms them into logical conditions. The management application further updates the relevant data sheet forms and license with the new parameters relating to the goods characteristics as required according to the new rules. Once all system records are updated, the management application informs the relevant Certified Users of new changes that may affect these users' operations.

The second procedure (502) enables Certified Users (or new applicants) to transmit their requests for new Licenses, to update existing ones, or/and to renew them, by filling e-forms at the relevant governmental web sites.

The check-up process requires human experts intervention, and is performed manually.

In cases of approved releases and handling of consignments, the system information is continuously updated (automatically), according to incoming goods data sheets which include detailed information of new type of goods.

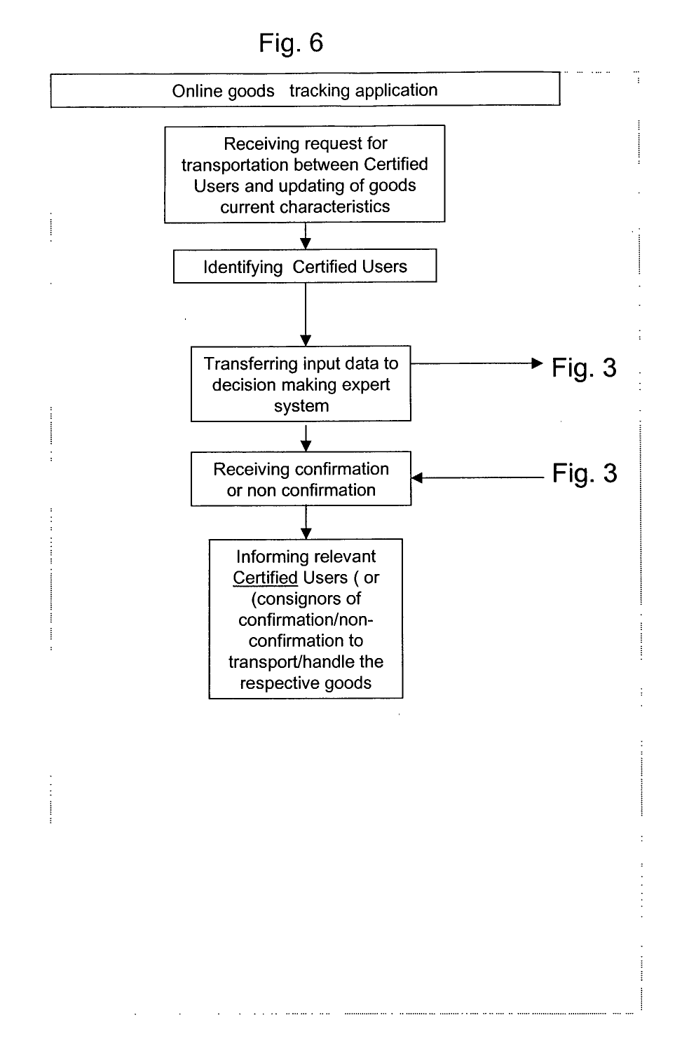

FIG. 6 illustrates a further implementation of the Supervision System according to the present invention. According to this implementation the Certified User is obliged to report any transportation of Goods Requiring Supervision to a second Certified User, or within the Certified organization, to the authorities. For example, transportation of hazardous material across the country between two different locations by the same Certified User, or relating a second Certified User, can be supervised by the authorities. The Certified Users transmit the relevant data information to the Supervision System and in return, receive confirmation or non-confirmation for proceeding with their transportation request.

According to the process of the present invention, customs authorities have no role in the identification, verification, and approval of contents details that are subjected to other agencies/authorities supervision and decision-making.

The supervision system, as suggested by the present invention, provides convenient and efficient online checkup process enabling 100% examination of all imported goods, reduced costs of business through e-commerce and “Just In Time” reporting and control over goods handling and transportation by Certified Users. It is especially useful in handling data received from “high-frequency” consignors, meaning those who are importing or exporting goods on a regular basis. Exceptional users, who use this service less frequently, are required to submit special forms at authorities' web sites. This process is also simple and quick.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A universal on-line expert system for automatic decision making in the release, handling, transportation and distribution of Goods Requiring Supervision, according to at least one set of Authorities' Rules and Regulations and license limitations of an Certified User relating said goods, said system comprising:
a. authorities rules database wherein the rules represent Authorities' Rules and Regulations regarding the flow of goods having specific characteristics.
b. Handling license database wherein each license represents a permission of specific Certified User to handle certain types of goods having specific characteristics.
c. Data sheet forms database wherein each form is adapted to a specific type of goods including all goods parameters of characteristics complying with all Authorities' Rules and Regulations.
d. Network interface means which enables the Certified User to transmit the goods' characteristics;
e. Automatic conditional logic program for checking the compliance of a Certified User goods' characteristics with authorities rules and respective license limitations;
f. Communication means for informing the Certified Users or the consignor (and all other relevant governmental participants of authorities' confirmation/non confirmation) for handling the respective goods.

2. The system of claim 1 wherein the authorities rules are further based on international customs code and the goods are classified according said international code;

3. The system of claim 1 wherein the Authorities' Rules and Regulations and licenses relate to international import/export;

4. The system of claim 1 wherein the Authorities' Rules and Regulations and licenses relate to national handling and transportation between Certified Users;

5. The system of claim 1 wherein the Authorities' Rules and Regulations and licenses relate to national transportation with a Certified User organization;

6. The system of claim 1 wherein the network interface means are implemented as a web-page within the Internet network enabling online data input;

7. The system of claim 1 wherein the network interface means are implemented as data exchange application enabling to import data input from source data application of the certified User and/or consignor to the expert system;

8. The system of claim 1 further comprising:
network interface means for editing or changing the Authorities' Rules and Regulations;
processing application for changing the goods data sheet according to updated Authorities' Rules and Regulations;

9. The system of claim 1 further comprising:
network interface means for editing or changing the licenses;
processing application for changing the goods data sheet according to updated licenses;

10. The system of claim 1 wherein the confirmation is preformed prior to the transportation of goods.

11. The system of claim 1 further comprising a smart card, said smart card including information of goods characteristics and respective Certified User license;

12. The system of claim 11 wherein the confirmation and validation process is based on the license data and goods characteristics data as retrieved from the smart card;

13. The system of claim 1 wherein the Automatic conditional logic program further examines combination of conditions relating different material characteristics according to pre-determined rules;

14. A checkup method for automatic confirmation of goods handling according to at least one set of Authorities' Rules and Regulations and license limitations of Certified Users where such rules regulations and licenses relate to the goods characteristics, said method comprising the steps of:
a. receiving electronic data input of goods characteristics wherein said characteristics represent all goods parameters which are required for all authorities rules and licenses;
b. Checking the compliance of a certified user's goods' characteristics with Authorities' Rules and Regulations;
c. Checking the compliance of a Certified User's goods' characteristics with respective license limitations;
d. Informing the consignor and/or the Certified User or the consignor (and all other relevant governmental participants of authorities' confirmation/non confirmation) for handling the respective goods.

15. The method of claim 14 further comprising the step of classifying the goods according to international customs code;

16. The method of claim 14 wherein the authorities rules and licenses relate to international import/export;

17. The method of claim 14 wherein the authorities rules and licenses relate to national handling and transportations between Certified Users;

18. The method of claim 14 wherein the authorities rules and licenses relate to national handling and transportation within the Certified User organization;

19. The method of claim 14 wherein for each type of goods is prepared designated data sheet including all parameters which are required for all authorities rules and licenses for receiving the electronic data input.

20. The method of claim 19 wherein electronic data input is received through online web page;

21. The method of claim 19 electronic data input is received through data exchange application enabling to import data input from source data application of the Certified User or consignor to the expert system;

22. The method of claim 14 further comprising the steps of:
editing or changing the authorities rules;
changing the goods data sheet according to updated authorities rules;

23. The method of claim 14 further comprising:
editing or changing the Certified User licenses;
changing the goods data sheet according to updated licenses;

24. The method of claim 14 wherein the checkup process is preformed prior to the transportation of goods.

25. The system of claim 14 wherein the confirmation process is based on the goods characteristic data as retrieved from the smart card, said smart card including information of goods characteristics and respective certified user license;

26. The method of claim 14 further comprising the step of checking combination of conditions relating different material characteristics according to pre-determined rules;
